(19) United States
(12) Patent Application Publication
(10) Pub. No.: US 2002/0184342 A1
(43) Pub. Date: Dec. 5, 2002

(54) Port monitoring methods and arrangements for enhanced document distribution

(76) Inventors: Kelli H. Kennedy, Boise, ID (US); Darrel D. Cherry, Meridian, ID (US); Garth F. Schmeling, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/874,432

(22) Filed: Jun. 4, 2001

(51) Int. Cl. G06F 15/16

(52) U.S. Cl. 709/219; 709/202; 709/246

(57) ABSTRACT

An enhanced port monitor is provided for managing communications between a source device and a service device in support of a document/file-handling process. The port monitor can support local printing/storing of files and provide selected files to remotely located service providers. Service providers may, for example, provide printing services, document/content distribution services, etc. The port monitor is configured with an agent process that uploads device-independent data within a file to the service device associated with a selected service provider. The agent process is also configured to launch a browser or like process to provide an interactive interface for the user in selecting particular services/features and providing other additional information as required to the service device. The service device, for example, can be a web-server or the like that is operatively coupled to the source device via a network. As a result of the enhanced port monitor, only one driver, e.g., a generic application-independent print driver, need be used. Furthermore, the improved methods and arrangements provided may also be extended to other forms of information or content.

### TECHNICAL FIELD

The present invention relates generally to computers and like devices, and more particularly to methods and arrangements that provide improved local and remote document processing and/or file-handling capabilities.

### BACKGROUND

In the past, devices such as personal computers (PCs) have been connected directly to printers. To print a document, a user would simply select that a file be sent to the connected printer. In response, software within the PC would send a print job to the printer, typically through a wired connection. The printer receives the print job and processes the received information, as needed, to generate a corresponding printed document. In an office environment, several PCs may be connected to one or more shared printers through a interconnecting network. Here, print jobs may be sent to a network printer or perhaps to a print server also connected to the network. The print server can be configured to manage print jobs destined for one or more network printers.

In the above exemplary configurations, the PCs/print servers are configured with the appropriate printer driver software associated with the printer(s) connected thereto. For example, a laser printer would have associated print driver software that provided the necessary file information and printing information to the laser printer as required to complete the printing of the corresponding document. As a result some computers are configured with several different selectable print drivers to provide the requisite compatibility to different printers.

Configuring a PC to operate with one or more printers can be a daunting task for the novice user. Thus, there is a continuing need for user-friendly configuration tools and/or techniques.

Currently, there is an effort underway to provide standard and enhanced file/document-handling services over larger network environments, such as, for example the Internet. Here, service providers are offering various file/document-handling services. For example, a user may configure their PC with client software that allows a file to be transmitted over the Internet to a server. For service providers that offer printing services, for example, the server is further connected to one or more printers equipped to generate the requested document. The resulting document can then be forwarded through the mail, for example, back to the user.

One of the drawbacks to such service providers appears to be the need to download special software and to configure the client PC to operate with the service provider. This special software typically includes print driver software. Thus, once again, the user is required to reconfigure their PC. This may also include the need to install updates to the special software in the future. Moreover, if a user would like to be able to select between a plurality of service providers when seeking file/document-handling services, then the user would need to install special software for each of the service providers. Such an effort may overwhelm a novice or even more experienced user. Likewise, maintaining such software in a managed multiple computer environment could prove time-consuming.

Consequently, there is a need for improved methods and arrangements that tend to reduce the complexity of the software required for a client computer or device. Preferably, the improved methods and arrangements will also be less burdensome or time consuming for users to implement.

### SUMMARY

Improved methods and arrangements are provided which significantly reduce the complexity of the software required for a client computer or device to employ remote service providers that assist with document/file-handling. The improved methods and arrangements tend to be easy to implement, quick to operate and user-friendly.

The above stated needs and others are met, for example, by a method that includes generating application-specific content at a source device, and converting the application-specific content into corresponding device-independent formatted data. Then, providing the device-independent formatted data to at least one service device connected to the source device, and further using the source device to interactively provide additional information associated with the device-independent formatted data to the service device. The method then includes causing the service device to process the device-independent formatted data based at least in part on the additional information. For example, the service device may be associated with a service provider that prints documents or distributes files/content to other devices/users.

Depending upon the implementation, the application-specific content may include graphical content (e.g., textual content, image content, and the like), video content, and/or audio content. In certain implementations, the application-specific content is converted into corresponding Graphics Device Interface (GDI) data, which is then further converted into corresponding device-independent formatted data. For example, the GDI data may be converted into corresponding intermediate formatted data, such as a Page Description Language (PDL) data like Postscript, etc., a Portable Document Format (PDF) data, or the like. The resulting device-independent formatted data can then be uploaded to the service device over the Internet, an intranet, a local area network (LAN), a wide area network (WAN), a TCP/IP-based network, a wireless communication link, a wire-based communication link, or other type of communication channel. For example, in certain implementations, the device-independent formatted data can be uploaded as one or more files using a HyperText Transfer Protocol (HTTP), a Secure HTTP (SHTTP), a File Transfer Protocol (FTP), or other suitable communication protocol.

In addition to providing the device-independent formatted data to the service device, a support program may be initiated, which provides a graphical user interface (GUI). The GUI can be configured to accept inputs establishing the additional information associated with the device-independent formatted data. In certain implementations, for example, the support program includes a browser application.

In accordance with certain implementations of the present invention, the source device may include a computer, a desktop personal computer (PC), a laptop PC, a personal digital assistant (PDA), a mobile communication device, or other similar device. The service device may include, for example, at least one computer operating as a server.

### BRIEF DESCRIPTION OF THE DRAWINGS

A more complete understanding of the various methods and arrangements of the present invention may be had by reference to the following detailed description when taken in conjunction with the accompanying drawings wherein:

FIG. 1 is a block diagram depicting a conventional networked environment that includes a computer operatively coupled to a plurality of other devices.

FIG. 2 is a block diagram depicting system having a source device that is operatively coupled through a communication channel to a service device, in accordance with certain implementations of the present invention.

FIG. 3 is a block diagram depicting a conventional software suite for use in a computer or like device, e.g., as in FIG. 1, and which supports printing/storing of a file(s) to another device.

FIG. 4 is a block diagram depicting an exemplary enhanced software suite for use in a source device that provides for the uploading of a file(s) to a service device, e.g., as in FIG. 2, and further related communication capabilities there between, in accordance with certain implementations of the present invention.

FIG. 5 is flow diagram depicting a method for uploading of a file(s) from a source device to a service device, e.g., as in FIG. 2, and providing further related communication capabilities there between, in accordance with certain implementations of the present invention.

### DETAILED DESCRIPTION

Reference is made to FIG. 1, which is a block diagram depicting an exemplary conventional networked environment 100 having various devices that support the distribution and/or printing of files as documents. In this example, a computer 102 is provided as an initial starting point for the creation of the file that will eventually be printed as a document or otherwise reproduced in some manner. Here, computer 102 may include any applicable device, for example, a desktop personal computer (PC), a laptop PC, a personal digital assistant (PDA), a mobile communication device, or the like. As is commonly known, the file (i.e., data) may be generated by one or more software applications (not shown) operating within computer 102. By way of example, a user of computer 102 may create a file using a word processing application, an electronic mail application, a spreadsheet application, a drawing application, a digital image-processing application, etc. Also, some files may be created automatically without the need for input from the user.

However created, the resulting file (or files) may be stored locally within computer 102, and/or provided to another device for further storage and/or processing. In FIG. 1, computer 102 is operatively connected to at least one network/interface 104. Network/interface 104 can include, for example, a local area network (LAN), a wide area network (WAN), the Internet, an intranet, a wireless network. In certain configurations, network/interface 104 may also include an interface cable, or the like.

Network/interface 104 is further operatively connected to a server 106. Server 106 can, for example, be used for storing files as received from computer 102 via network/interface 104. Hence, as is well known, server 106 may be used to provide remote, centralized storage for a plurality of computers connected to network/interface 104. Server 104 may also be configured to act as a print server.

A printer 108 is operatively connected to network/interface 104. Printer 108, which may be color or monochrome, for example, can include a laser printer, an ink jet printer, a plotter, an impact printer, or the like. Computer 102 or server 106 can be configured to send a print job to printer 108. Here, the print job may include the file itself or a corresponding printer-readied version of the file, and possibly other information required by the printer to complete the printing of the associated document(s). As is well known, there are a variety of different media on which file information may be transferred/affixed or otherwise provided thereon.

In addition to printer 108, computer 102 or server 106 can, in this example, also direct a print job to a service provider 110, which is also operatively connected to network/interface 104. Here, service provider 110 can include one or more other computers, servers, etc., which are configured to provide file/document-handling services. By way of example, service provider 110 may include a web-based server that provides file printing or perhaps additional file distribution services when provided with one or more files from a client. Thus, computer 102 acting as a client device may provide a file to service provider 110 over the World Wide Web portion of the Internet along with instructions regarding the handling of the file. One example of such services is provided through www.Mimeo.com, which provides a variety of printing services, including color and monochrome printing, document binding, etc. Another example of such services is provided through www.HotSend.com, which provides file distribution services. For example, by employing the services of HotSend.com, a user may share a variety of application-specific file information (e.g., different formatted documents) with other users without requiring that the other users to have access to the applicable application(s).

It is anticipated that file/document-handling services, such as those described above and others, will become more popular, especially with the continued growth of the Internet and corporate/organizational intranets. Unfortunately, many of these new and advantageous services require that the client computer be further configured with special software designed to access the desired service and/or otherwise prepare the file as needed for further handling by the service. Both www.Mimeo.com and www.HotSend.com require that the user download and install special software in the client computer before utilizing their respective services. Mimeo.com, for example, requires a unique print driver to be loaded and configured with a PC's operating system. HotSend.com also requires special software/drivers to be installed.

For users that would like to have the ability to access several different file/document-handling services, additional software (e.g., drivers, etc.) will likely need to be downloaded or otherwise provided and operatively configured in the client computer. This tends to increase the complexity of the software suite on the client computer. Moreover, some users may find this to be too burdensome and may, for this reason or others, decide not to even begin to employ the services of service provider 110.

Consequently, as mentioned above, it would be advantageous to reduce the complexity of the software required for a client computer or device, and/or to reduce the burden on users.

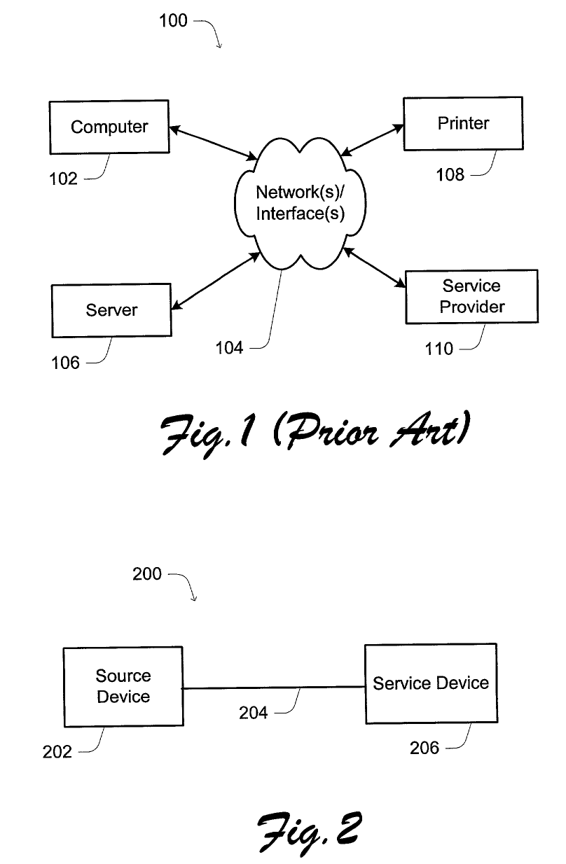

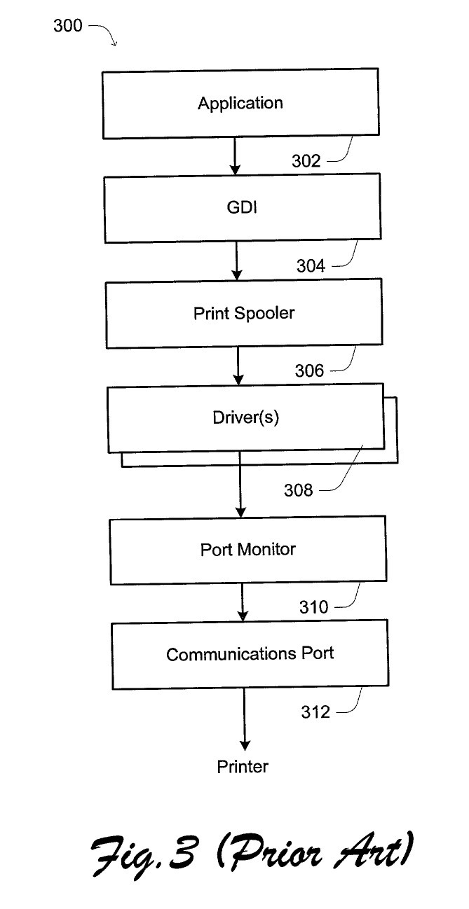

With this in mind, attention is drawn to FIG. 2, which is a block diagram that depicts an exemplary environment 200 having a source device 202 operatively connected through a communication channel 204 to a service device 206. Environment 200 may include environment 100 of FIG. 1, for example, or other applicable configuration. For example, source device 202 may include computer 102 or server 106, communication channel 204 may include network/interface 204, and service device 206 may include one or more printers 108, and/or one or more service providers 110, as described above. FIG. 2 is meant to illustrate that the exemplary methods and arrangements described below, in accordance with the present invention, are applicable to various configurations, wherein source device 202 provides file information and/or the like, as required, to at least one service device 206.

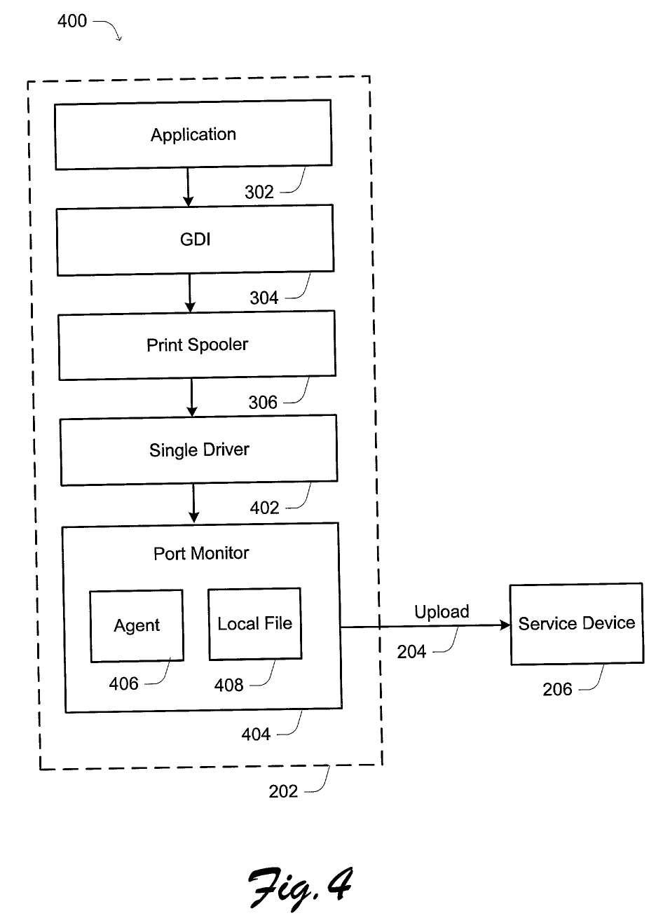

To provide additional background information, an exemplary conventional file printing software suite 300 is depicted as a block diagram in FIG. 3. Software suite 300 may be implemented, for example, in computer 102 of FIG. 1, or in source device 202 of FIG. 2. This exemplary software suite 300 is associated with conventional Microsoft Windows® operating system software available for PCs, Servers, and the like.

Here, software suite 300 includes an application 302 with which the user may create a file to be printed. When ready to print the file, the user would input a print command, for example, by using a mouse or other pointing mechanism to selectively scroll through a pull down menu in a graphical user interface (GUI) and selecting “PRINT” from a list of commands. In response to the user input, application 302 causes a Graphics Device Interface (GDI) 304 to generate a stream of corresponding print device-independent data based on the application-specific file that is to be printed. This is often referred to as a GDI representation of the file.

The resulting GDI representation is then handled by print spooler 306, which essentially manages the print job that includes the GDI representation. For example, print spooler 306 is configured to provide the GDI representation to an appropriate print driver 308. Print driver 308 is configured to convert/translate the GDI representation into corresponding print device-dependent data. For example, print driver 308 may convert the GDI representation into a specific Page Description Language (PDL) associated with the printer or print service that is to be used in printing the document. The resulting PDL or like data is then be passed on, within the print job, to a port monitor 310.

Port monitor 310 is basically responsible for directing print jobs to the desired local printer, network printer or to a file. A print job may be divided into a plurality of portions, which are subsequently provided to a printer or print service through communications port 312 to the selected printer.

As described above, conventional print services require special software, which includes a special print driver. To selectively send print jobs (or file distribution jobs) to different service providers a plurality of drivers are required. These special print drivers are typically configured to convert/translate the GDI representation into an appropriate format associated with the service provider, and forward the resulting data to the service provider for processing by employing available communication software/hardware in the PC.

FIG. 4 is a block diagram depicting an improved software suite/configuration 400, in accordance with certain exemplary implementations of the present invention. While this exemplary software suite is directed towards certain conventional Windows® based operating systems, it should be understood that the improved methods and arrangements as described herein are not necessarily limited to Windows® based operating systems and associated devices. Instead, the improved methods and arrangements are clearly applicable to similar functional processes in other operating systems and devices.

With this in mind, software suite/configuration 400 includes application 302, GDI 304, and print spooler 306, for example, as described above with regard to FIG. 3. Rather than having a plurality of print drivers to support, for example, a plurality of print services, software suite/configuration 400, only includes a single driver 402.

It should be noted that in other implementations, software suite/configuration 400 can include additional drivers, when needed, for example, when the PC is also connected to local printers, etc.

Nevertheless, in accordance with certain aspects of the present invention, a plurality of different service devices 206 (see, e.g., FIG. 2) can be effectively supported using single driver 402. Here, single driver 402 may be a generic print driver, such as, for example., a universal PostScript driver that converts the GDI representation into corresponding PostScript formatted data. The resulting print job is then provided to a modified port monitor 404.

Modified port monitor 404 includes an agent program 406 that is configured to “upload” a local file 408 to a service device 206 via communications channel 204. Here, local file 408 includes the resulting print job (or resulting file distribution job).

In accordance with certain exemplary implementations of the present invention, local file 408 can be uploaded to service device 206 using a variety of conventional protocols, such as, e.g., HyperText Transfer Protocol (HTTP), Secure HTTP (SHTTP), File Transfer Protocol (FTP), or the like.

Further, in certain implementations, agent program 406 is configured to launch a web-browser, interactive process, or like supporting application 410 that is capable of providing interactive communication between the client computer (i.e., the user) and a remote service device 206. Supporting application 410, in certain exemplary implementations is preferably configured to present a GUI to the user that allows the user to select between different service devices 206, and select printing/handling attributes applicable to the selected service device. For example, supporting application 410 may allow the user to select the type of printing to be done (e.g., color laser, color inkjet, or perhaps the monochrome equivalents, etc.), the type of media to be used (material, weight, size, color, etc.), the number of copies to be printed, the binding methods, and the like. Supporting application 410 may also be used to collect information from and about the user, such as, for example, the user's name, address, account number(s), etc. In the case of a document distribution service provider, supporting application 410 may further collect information about the intended recipients, such as, e.g., physical addresses, electronic-mail addresses, etc., as needed.

Thus, in accordance with certain further aspects of the present invention, agent program 406 and supporting application 410 can be implemented to provide the user with a robust and user-friendly interface through which a plurality of service devices 206 can be selectively engaged to provide certain services. Instructions regarding the printing/distribution of the uploaded file(s) can therefore be communicated to service device 206.

As a result, the user is not required to install/maintain a plurality of drivers in source device 202. If the service device requires a different data format than that which is provided in the print job, then service device 206 can further process the data and convert/translate the file information as required. Hence, the user will not need to be burdened by future software updates. Any software changes required will be made to the service provider's software. The most that the user will likely notice may be changes made to the web-based GUI presented to the user for identifying print/document handling features.

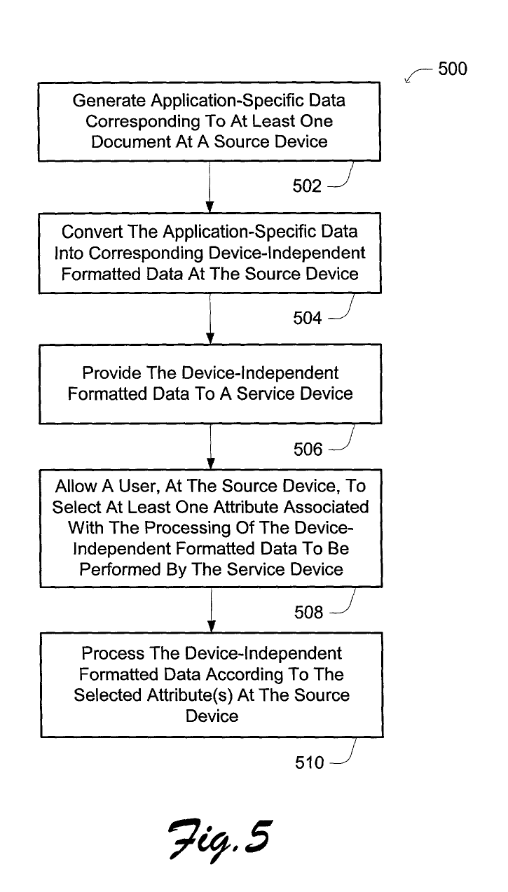

Reference is now made to FIG. 5, which is a flow diagram depicting a exemplary printing/document-handling process 500, in accordance with certain exemplary implementations of the present invention. In step 502, application-specific data corresponding to at least one document is generated at a source device 202. Next, in step 504, the application-specific data is converted into corresponding device-independent formatted data at source device 202. In step 506 the device-independent formatted data is provided to a service device 206. Then, in step 508, a user, for example, at source device 202, is allowed to select at least one attribute associated with the processing of the device-independent formatted data by service device 206. In step 510, the device-independent formatted data is processed at service device 206, according to the selected attribute(s).

In accordance with certain implementations of the present invention, the file or files are uploaded prior to initiating supporting application 410. In other implementations, supporting application 410 is initiated prior to uploading the file or files. In still other implementations, the uploading of the file or files and the initiation of supporting application 410 occur simultaneously.

Thus, although some preferred implementations of the various methods and arrangements of the present invention have been illustrated in the accompanying Drawings and described in the foregoing Detailed Description, it will be understood that the invention is not limited to the exemplary implementations disclosed, but is capable of numerous rearrangements, modifications and substitutions without departing from the spirit of the invention as set forth and defined by the following claims.

What is claimed is:

1. A method comprising:
generating application-specific content at a source device;
converting the application-specific content into corresponding device-independent formatted data;
providing the device-independent formatted data to at least one service device operatively coupled to the source device;
using the source device to interactively provide additional information associated with the device-independent formatted data to the service device; and
causing the service device to process the device-independent formatted data based at least in part on the additional information.

2. The method as recited in claim 1, wherein generating application-specific content further includes creating at least one file having data that represents content selected from a group comprising graphical content, video content, and audio content.

3. The method as recited in claim 2, wherein the graphical content includes graphical content selected from a group comprising textual content and image content.

4. The method as recited in claim 2, wherein causing the service device to process the device-independent formatted data based at least in part on the additional information further includes printing at least one document corresponding to the graphical content.

5. The method as recited in claim 2, wherein causing the service device to process the device-independent formatted data based at least in part on the additional information further includes selectively distributing at least one file corresponding to the graphical content.

6. The method as recited in claim 1, wherein converting the application-specific content into corresponding device-independent formatted data further includes converting the application-specific content into corresponding Graphics Device Interface (GDI) data.

7. The method as recited in claim 6, wherein converting the application-specific content into corresponding device-independent formatted data further includes converting the GDI data into corresponding Page Description Language (PDL) data.

8. The method as recited in claim 7, wherein the PDL data includes at least one type of formatted data selected from a group of different types of formatted data that includes PostScript formatted data and Portable Document Format (PDF) formatted data.

9. The method as recited in claim 1, wherein providing the device-independent formatted data to the at least one service device further includes uploading the device-independent formatted data to the service device over a network.

10. The method as recited in claim 9, wherein the network is selected from a group of networks comprising the Internet, an intranet, a local area network (LAN), a wide area network (WAN), a TCP/IP-based network, a wireless communication link, and a wire-based communication link.

11. The method as recited in claim 9, wherein uploading the device-independent formatted data to the service device over the network further includes using a communication protocol to upload at least one file, the communication protocol being selected from a group of protocols comprising a HyperText Transfer Protocol (HTTP), Secure HTTP (SHTTP), and a File Transfer Protocol (FTP).

12. The method as recited in claim 9, wherein using the source device to interactively provide additional information associated with the device-independent formatted data to the service device further includes operating at least one support program on the source device that communicates over the network with the service device.

13. The method as recited in claim 12, wherein the at least one support program provides a graphical user interface (GUI) configured to accept inputs establishing the additional information associated with the device-independent formatted data.

14. The method as recited in claim 13, wherein the at least one support program includes a browser application.

15. The method as recited in claim 1, wherein using the source device to interactively provide additional information associated with the device-independent formatted data to the service device further includes causing a port monitor process to launch at least one support program on the source device that communicates over the network with the service device.

16. The method as recited in claim 1, wherein the source device is selected from a group of client devices comprising a computer, a desktop personal computer (PC), a laptop PC, a personal digital assistant (PDA), and a mobile communication device.

17. The method as recited in claim 16, wherein the source device includes a computer operatively configured with a Windows® operating system.

18. The method as recited in claim 1, wherein the service device includes at least one computer operating as a server.

19. A computer-readable medium having computer instructions for performing acts comprising:
causing a source device to convert application-specific content into corresponding device-independent formatted data and output the device-independent formatted data to at least one service device; and
configuring the source device to interactively provide additional information associated with the device-independent formatted data to the service device.

20. The computer-readable medium as recited in claim 19, wherein the application-specific content is provided in at least one file having data that represents content selected from a group comprising graphical content, video content, and audio content.

21. The computer-readable medium as recited in claim 20, wherein the graphical content includes graphical content selected from a group comprising textual content and image content.

22. The computer-readable medium as recited in claim 19, wherein causing the source device to convert application-specific content into corresponding device-independent formatted data further includes converting the application-specific content into corresponding Graphics Device Interface (GDI) formatted data.

23. The computer-readable medium as recited in claim 22, wherein converting the application-specific content into corresponding device-independent formatted data further includes converting the GDI data into corresponding Page Description Language (PDL) data.

24. The computer-readable medium as recited in claim 23, wherein the PDL data includes at least one type of formatted data selected from a group of different types of formatted data that includes PostScript formatted data and Portable Document Format (PDF) formatted data.

25. The computer-readable medium as recited in claim 19, wherein causing the source device to output the device-independent formatted data to the at least one service device further includes uploading the device-independent formatted data to the service device over a network.

26. The computer-readable medium as recited in claim 25, wherein the network is selected from a group of networks comprising the Internet, an intranet, a local area network (LAN), a wide area network (WAN), a TCP/IP-based network, a wireless communication link, and a wire-based communication link.

27. The computer-readable medium as recited in claim 25, wherein uploading the device-independent formatted data to the service device over the network further includes using a communication protocol to upload at least one file, the communication protocol being selected from a group of protocols comprising a HyperText Transfer Protocol (HTTP), a Secure HTTP (SHTTP), and a File Transfer Protocol (FTP).

28. The computer-readable medium as recited in claim 25, wherein configuring the source device to interactively provide additional information associated with the device-independent formatted data to the service device further includes operating at least one support program on the source device that is configurable to communicate over the network with the service device.

29. The computer-readable medium as recited in claim 28, wherein the at least one support program provides a graphical user interface (GUI) configured to accept inputs establishing the additional information associated with the device-independent formatted data.

30. The computer-readable medium as recited in claim 29, wherein the at least one support program includes a browser application.

31. The computer-readable medium as recited in claim 19, wherein configuring the source device to interactively provide additional information associated with the device-independent formatted data to the service device further includes causing a port monitor process to launch at least one support program on the source device that communicates over the network with the service device.

32. The computer-readable medium as recited in claim 19, wherein the source device is selected from a group of client devices comprising a computer, a desktop personal computer (PC), a laptop PC, a personal digital assistant (PDA), and a mobile communication device.

33. The computer-readable medium as recited in claim 32, wherein the source device includes a computer operatively configured with a Windows® operating system.

34. The computer-readable medium as recited in claim 19, wherein the service device includes at least one computer operating as a server.

35. An apparatus comprising logic configured to generate application-specific content, convert the application-specific content into corresponding device-independent formatted data, output the device-independent formatted data to at least one service device, and interactively provide additional information associated with the device-independent formatted data to the service device.

36. The apparatus as recited in claim 35, wherein the content includes content selected from a group comprising graphical content, video content, and audio content.

37. The apparatus as recited in claim 36, wherein the graphical content includes graphical content selected from a group comprising textual content and image content.

38. The apparatus as recited in claim 35, wherein the logic is configured to convert the application-specific content into corresponding Graphics Device Interface (GDI) data.

39. The apparatus as recited in claim 38, wherein the logic is further configured to convert the GDI data into corresponding Page Description Language (PDL) data.

40. The apparatus as recited in claim 39, wherein the PDL data includes at least one type of formatted data selected from a group of different types of formatted data that includes PostScript formatted data and Portable Document Format (PDF) formatted data.

41. The apparatus as recited in claim 35, wherein the logic is configurable to upload the device-independent formatted data to the service device over a network.

42. The apparatus as recited in claim 41, wherein the network is selected from a group of networks comprising the Internet, an intranet, a local area network (LAN), a wide area network (WAN), a TCP/IP-based network, a wireless communication link, and a wire-based communication link.

43. The apparatus as recited in claim 41, wherein the logic is configurable to upload the device-independent formatted data to the service device using a communication protocol selected from a group of protocols comprising a HyperText Transfer Protocol (HTTP), a Secure HTTP (SHTTP), and a File Transfer Protocol (FTP).

44. The apparatus as recited in claim 41, wherein the logic is configurable to interactively communicate with the service device over the network via a graphical user interface (GUI) that is configured to accept inputs establishing the additional information associated with the device-independent formatted data.

45. The apparatus as recited in claim 35, wherein the logic includes a port monitor process.

46. A system comprising:
a communication network;
at least one service device operatively coupled to the communication network and configured to provide at least one file handling process;
a source device operatively coupled to the communication network and configured to generate application-specific content, convert the application-specific content into corresponding device-independent formatted data, output the device-independent formatted data to the at least one service device, and interactively provide additional information associated with the device-independent formatted data to the service device.

47. The system as recited in claim 46, wherein the content includes content selected from a group comprising graphical content, video content, and audio content.

48. The system as recited in claim 47, wherein the graphical content includes graphical content selected from a group comprising textual content and image content.

49. The system as recited in claim 46, wherein the source device is configured to convert the application-specific content into corresponding Graphics Device Interface (GDI) data.

50. The system as recited in claim 49, wherein the source device is further configured to convert the GDI data into corresponding Page Description Language (PDL) data.

51. The system as recited in claim 50, wherein the PDL data includes at least one type of formatted data selected from a group of different types of formatted data that includes PostScript formatted data and Portable Document Format (PDF) formatted data.

52. The system as recited in claim 46, wherein the network is selected from a group of networks comprising the Internet, an intranet, a local area network (LAN), a wide area network (WAN), a TCP/IP-based network, a wireless communication link, and a wire-based communication link.

53. The system as recited in claim 52, wherein the source device is configured to upload the device-independent formatted data to the service device using a communication protocol selected from a group of protocols comprising a HyperText Transfer Protocol (HTTP), a Secure HTTP (SHTTP), and a File Transfer Protocol (FTP).

54. The system as recited in claim 52, wherein the source device is configured to interactively communicate with the service device over the network via a graphical user interface (GUI) that is configured to accept inputs establishing the additional information associated with the device-independent formatted data.

55. The system as recited in claim 54, wherein the source device is configured to provide the GUI using a browser application.

56. The system as recited in claim 55, wherein the source device is configured to use a port monitor process to launch the browser application.

57. The system as recited in claim 46, wherein the source device is selected from a group of client devices comprising a computer, a desktop personal computer (PC), a laptop PC, a personal digital assistant (PDA), and a mobile communication device.

58. The system as recited in claim 46, wherein the service device includes at least on computer operating as a server.
